(19) United States
(12) Patent Application Publication
(10) Pub. No.: US 2010/0269695 A1
(43) Pub. Date: Oct. 28, 2010

(54) SEPARATION PUMP

(75) Inventor: Tom Cichoracki, Helsinki (FI)

Correspondence Address: BROWDY AND NEIMARK, P.L.L.C.;624 NINTH STREET, NW, SUITE 300, WASHINGTON, DC, 20001-5303, US

(73) Assignee: POM TECHNOLOGY OY AB, HELSINKI (FI)

(21) Appl. No.: 12/670,446

(22) PCT Filed: Jul. 1, 2008
(86) PCT No.: PCT/FI08/50399

§ 371 Date: Jun. 28, 2010

(30) Foreign Application Priority Data
Jul. 23, 2007 (FI) 20075558

(51) Int. Cl. B01D 19/00; D21D 5/26; F04D 7/04

(52) U.S. Cl. 95/242; 96/177

(57) ABSTRACT

The invention relates to a separation pump (1) for pumping a fluid mixture (2) of gas (3) and liquid or suspension (4) and for separating gas (3) and liquid or suspension (4) from each other. The separation pump (1) comprising a rotatable drum means (10) for rotating fluid mixture (2). The rotatable drum means (10) having an inner wall (11) and an inner space (12). The rotatable drum means (10) being rotatable for causing liquid or suspension (4) of fluid mixture (2) to form a layer of liquid or suspension (4) on the inner wall (11) and for causing gas (3) of the fluid mixture (2) to migrate towards the axis of rotation (13). The separation pump comprises foam discharging means (15) for discharging foam (16) from the inner space (12) of the rotatable drum means (10). The foam discharging means (15) comprises a second outlet (17).

### BACKGROUND OF INVENTION

1. Field of the Invention

The present invention relates to a separation pump as claimed in the preamble of independent claim 1.

The present invention relates also to the use of a separation pump.

Gas removal in various process steps such as in various steps of pulping is often inhibited due to foam, which is created in the various process steps, because gas is trapped in the foam or because the foam is so viscous that it prevents free gas flow.

On the other hand, foam can be used for separating components from a mixture, in other words, for separating the components of the foam from the liquid or (liquid) suspension. In addition, foam is an excellent carrier for gas, in other words, for separation of gas from a mixture containing gas and liquid or liquid suspension, since gas is a component of foam. For example in pulp mill processes, foam is a result of air mixing with the soap/tall oil coming from the raw materials. In pulp mill processes foam is utilized to separate soap/tall oil from a filtrate for example by flotation and skimming. In this way can for example in flotation processes gas and various components be separated from the rest of a mixture in the form of foam containing gas and the component(s) to be separated.

2. Prior Art

Publication WO 94/17242 discloses an apparatus for separating fibers from fibre-containing water. The apparatus comprises means for feeding fibre-containing water into said apparatus, means for feeding gas into said water for forming fibre-enriched foam, and means for discharging fibre-depleted water and fibre-enriched foam from said apparatus. The apparatus comprises a mantle shaped essentially as a body of revolution and means for causing said fibre-containing water to rotate in a vortex on the inner surface on said mantle. The means for feeding gas into said water comprise a gas distribution part of said mantle for feeding finely distributed gas into the vortical water. The means for discharging fibre-enriched foam extend into the area of a foam column generated in the center of said stationary mantle. The discharging means are preferably connected to a foam extinguishing apparatus. This apparatus does not provide for gas separation from the fibre-containing water i.e. the liquid.

Publication WO 95/17235 discloses an apparatus for pumping and separating a mixture of gas and liquid according to the preamble of independent claim 1. In this publication foam is considered as being an obstacle for gas separation and it is in this publication suggested to collapse foam inside the rotatable drum means by spraying the foam. This arrangement does not allow separating the components of the foam from the liquid or liquid suspension in the separation pump, because when the foam collapses, the components of the foam will mix up with the liquid or liquid suspension.

### SHORT DESCRIPTION OF THE INVENTION

In the past, as for example in a separation pump as disclosed in WO 95/17235, foam was considered as a problem in separation pumps and as a problem for the proper function of separation pumps. On the other hand, because foam is used as a carrier for removing gas and other components from a mixture for example in flotation and skimming, it would be desirable if foam could be removed in the form of foam from the inner space of a rotatable drum means of a separation pump without collapsing the foam inside the inner space of the rotatable drum means. This would allow separating components of the foam from the mixture in a separation pump and/or separation of components capable of foaming from the mixture in a separation pump. This would in addition allow separation of foam in general from the mixture in a separation pump.

The purpose of the invention is to provide a separation pump, which is capable of separating in addition to gas from a mixture of gas and liquid or suspension also such components of the mixture capable of foaming (i.e. such components which may be a part of foam) and/or such components which are components of a foam present in the mixture of gas and liquid or suspension fed into the separation pump.

A separation pump according to the invention is characterized by the features defined in independent claim 1.

Preferred embodiments are presented in the independent claims of the invention.

In a separation pump according to the present invention, the separation pump comprises foam discharging means for discharging foam from the inner space of the rotatable drum of the separation pump. The foam discharging means of a separation pump according to the invention also comprises a second outlet for preferably leading out foam and/or components of the foam from the inner space of the separation pump so that the foam and/or components of the foam does not mix up with the essentially gas-free liquid or the essentially gas-free liquid suspension in the inner space of the separation pump, which essentially gas-free liquid or suspension is lead out from the inner space of the separation pump via a first outlet.

The gas, which is separated from the mixture of gas and liquid or suspension in the separation pump can be completely a part of the foam in other words be completely trapped in the foam. It is also possible that a part of the gas which is separated from the mixture of gas and liquid and suspension in the separation pump is free in other words not a part of the foam. If the mixture of gas and liquid or suspension fed to the separation pump contains no such components, which can produce foam with gas and/or no foam, all of the gas which is separated from the mixture of gas and liquid and suspension in the separation pump is free i.e. not a part of any foam.

The separation pump of the invention can for example be used in pulp mill processes. Also other uses are possible, where gas and a component capable of foaming are to be removed from liquid or suspension. The separation pump according to the invention can also be used for removing foam from a mixture of gas and liquid or suspension in a process.

The foam discharging means are preferably, but not necessarily, provided at the axis of rotation of the rotatable drum means, because foam tends to migrate towards the axis of rotation of the rotatable drum means rotates, because foam is less dense than liquid or suspension.

In a preferred embodiment of the invention, the foam discharging means are provided at the axis of rotation of the rotatable drum means, at the outlet end of the separation pump. In such embodiment the foam is discharged from the same end of the inner space of the rotatable drum means as the essentially gas-free liquid or essentially gas-free suspension. This means that the foam to be discharged from the inner space of the rotatable drum means does not have to be moved or to flow in a direction against the flow of the mixture of gas and liquid or suspension or against the flow of gas-free liquid or gas-free suspension in the inner space of the rotatable drum means.

In a preferred embodiment of the invention, the separation pump comprises foam breaking means for at least partly breaking down the foam. These may be mechanical means for breaking down the foam and/or may use some additive for example a chemical for breaking down the foam. Alternative or in addition, the foam may for example be sprayed with a fluid in order to break down the form. Alternatively, the foam may be discharged from the separation pump in the form of foam and broken down later, outside the separation pump.

In a preferred embodiment of the invention, the foam discharging means of the separation pump comprises a foam extraction chamber for receiving foam from the inner space of the rotatable drum means. The foam extraction chamber may form an extension of the inner space of the rotatable drum means at the outlet end of the separation pump. An advantage of such a foam extraction chamber is that it forms a space for the foam, which prevents foam and/or components of the foam inside the separation pump from mixing up with the essentially gas-free liquid or essentially gas-free suspension leaving the separation pump at the first outlet.

In a preferred embodiment of the invention, the separation pump comprises foam moving means for causing a flow of foam from the inner space of the rotatable drum means towards the foam discharging means, preferably into a foam extraction chamber if the separation pump is provided with such a foam extraction chamber.

In a preferred embodiment of the invention, the separation pump is provided with a pressure increasing means for creating a pressure inside the inner space of the rotatable drum means for pressing foam towards the foam discharging means.

In a preferred embodiment of the invention, the separation pump is provided with a pressure decreasing means for creating a pressure inside the inner space of the rotatable drum means for sucking foam towards the foam discharging means.

In a preferred embodiment of the invention, the separation pump comprises a set of blades for rotating the fluid mixture at the inlet end of the rotatable drum means. Additional rotating (mixing) of the fluid mixture in addition to rotating the fluid mixture with the rotating drum means promotes the formation of foam and therefore promotes separation of foaming components from the fluid mixture.

In a preferred embodiment of the invention, the separation pump is provided with a third inlet for feeding an additive i.e. foaming agent into the mixture of gas and suspension or liquid to enhance foaming (forming of foam).

The separation pump of the invention is particularly suitable for removing soap from a mixture in a pulp mill process. The invention relates also to the use of a separation pump according to the invention for removing soap from a mixture in a pulp mill process. All wood species contain extractive substances. Some of these substances are dissolved into liquor in the pulping process. For example resin and fatty acids are dissolved into pulping liquor and form sodium salts, which are surface active compounds (less dense than surrounding liquor) and have a potential for “washing” other components out of wood by micelle formation. These Na-salts are typically called soap in the pulp and paper industry. Soap is primarily related to softwoods although there are also some soap in hardwoods also, but not in the same extent as with softwoods.

### SHORT DESCRIPTION OF THE FIGURES

The present invention, together with additional objects and advantages of preferred embodiments of the invention will best be understood from the following description, when read in connection with the accompanying drawings, of which:

FIG. 1 shows in section view a separation pump according to a first embodiment of the invention,

FIG. 2 shows in section view a separation pump according to a first embodiment of the invention in use and partly filled with fluid mixture, liquid or suspension, gas and foam,

FIG. 3 is a section view of the foam extraction chamber of the separation pump shown in FIG. 1 along line A-A in FIG. 1,

FIG. 4 shows in section view a separation pump according to a second embodiment of the invention,

FIG. 5 shows in section view a separation pump according to a third embodiment of the invention,

FIG. 6 shows the use of a separation pump according to the invention in a pulp process,

FIG. 7 shows in section view a separation pump according to a fourth embodiment of the invention, and

FIG. 8 shows in section view a separation pump according to a fifth embodiment of the invention.

### DETAILED DESCRIPTION OF PREFERRED EMBODIMENTS OF THE INVENTION

It is to be noted that the present separation pump operates largely in the same manner as the apparatus described in WO 95/17235 except for the features relating to handling foam. Reference is made to the detailed description in said publication, it being clear to those skilled in the art that the many variations in the general construction and operation of the prior art pump are applicable to large extent also to the separation pump according to the present invention.

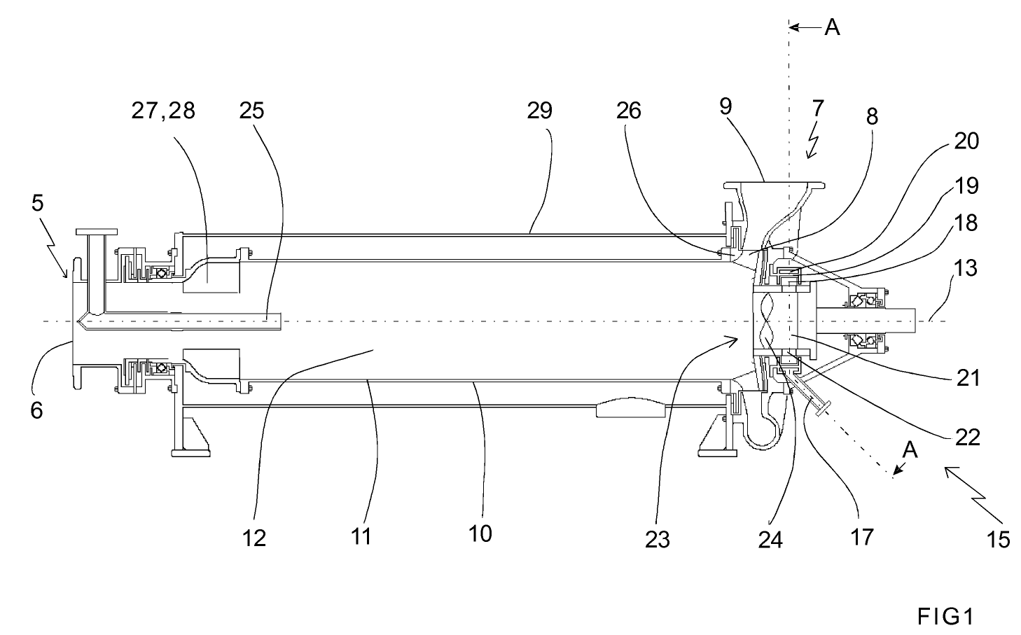

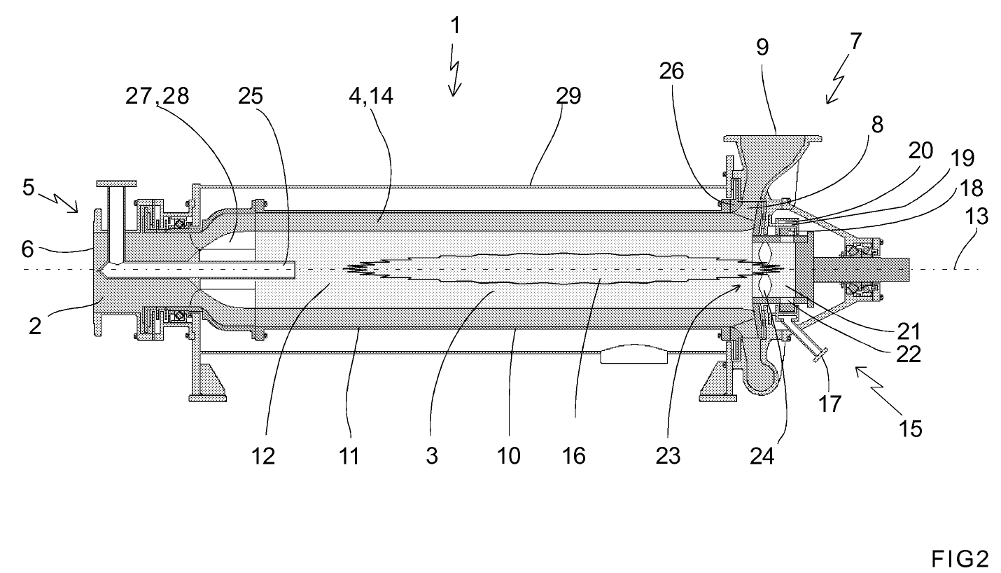

FIGS. 1 to 4 shows in section view a separation pump 1 for pumping fluid mixture 2 of gas and liquid or suspension and for at least partly separating gas 3 and liquid or suspension 4 from each other.

An example of a suspension is filtrate or filtration water.

The separation pump 1 shown in FIGS. 1 to 4 comprises an inlet end 5 with a stationary fluid mixture inlet 6. At an opposite outlet end 7, the separation pump 1 comprises a stationary pump housing 8 with a liquid outlet or suspension outlet 9 (hereafter called “first outlet 9”).

The separation pump 1 shown in FIGS. 1 to 4 comprises also a rotatable drum means 10 for rotating fluid mixture 2 fed through the fluid mixture inlet 6. The rotatable drum means 10 is in FIGS. 1 to 3 provided between the stationary fluid mixture inlet 6 and the stationary pump housing 8. In FIGS. 1 to 3 said rotatable drum means is mounted in bearings (not marked with reference numerals).

The rotatable drum means 10 shown in the figures has an essentially circular cross-section. The rotatable drum means 10 has an inner wall 11. Because the rotatable drum means 10 is hollow, the inner walls 11 of the rotatable drum means 10 forms an inner space 12.

The rotatable drum means 10 are rotatable around an axis of rotation 13 for causing liquid or suspension 4 of fluid mixture 2 fed into the rotatable drum means 10 via the fluid mixture inlet 6 to form a layer of liquid or suspension 14 on the inner wall 11 and for causing gas 3 of fluid mixture 2 fed into the rotatable drum means 10 via the fluid mixture inlet 6 to migrate towards the axis of rotation 13 of the rotatable drum means 10.

The separation pump 1 comprises in addition a foam discharging means 15 for removing foam 16 from the inner space 12 of the rotatable drum means 10. The foam discharging means 15 comprises a second outlet 17 for discharging foam 16 or at least partly broken down foam 16 and gas 3 from the foam discharging means 15.

The foam discharging means 15 are preferably, but not necessarily, provided at the outlet end 7 of the separation pump 1.

The foam discharging means 15 are preferably, but not necessarily, provided at the axis of rotation 13 of the rotatable drum means 10, and in addition preferable at the outlet end 7 of the separation pump 1.

The foam discharging means 15 are in FIG. 1 provided with mechanical foam breaking means for breaking down the foam 16 mechanically.

Alternatively, or in addition to the mechanical foam breaking means, the second pump means may be provided with chemical foam breaking means (not shown in the figures) for breaking down the foam using chemicals (not shown in the figures).

In FIG. 1, the mechanical foam breaking means comprises rotating vanes 18 for breaking the foam.

In FIG. 1, the mechanical foam breaking means comprises a screen 19 for breaking the foam.

In FIG. 1, the rotating vanes 18 are adapted to co-operate with the screen 19 to force foam with the rotating vanes 18 through the screen 19 to a collector 20 for receiving the foam, which has been at least partly broken down by means of the rotating vanes 18 and the screen 19. The collector 20 is in communication with the second outlet 17 for leading collapsed foam out of the separation pump 1, in other words, out of the foam discharging means 15.

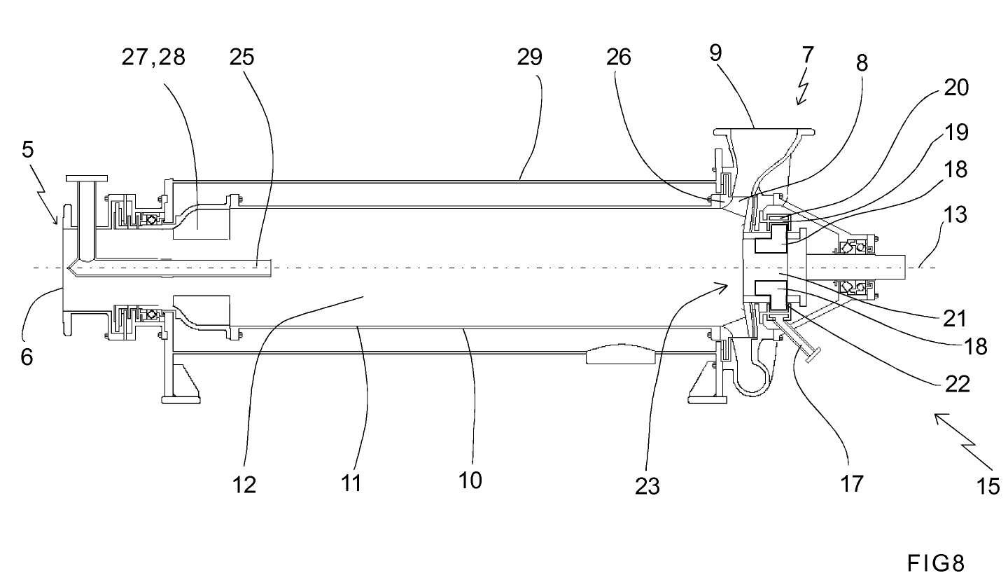

In the fifth embodiment shown in FIG. 8, rotating vanes 18 for forcing foam through a screen 19 for at least partly breaking down foam extend into an inner space (not marked with a reference number) of the form extraction chamber 21. In FIG. 8, the rotating vanes 18 form also foam moving means 23 for causing foam to flow from the inner space 12 of the rotatable drum means 10 towards the foam discharging means 15. In FIG. 8 the rotating 8 action of the rotating vanes 18 is also preferably, but not necessarily, configured to at least partly break down foam prior feeding and forcing foam through the screen 19.

In FIG. 1, the foam discharging means comprises a foam extraction chamber 21 for receiving foam from the inner space 12 of the rotatable drum means 10. The foam extraction chamber 21 is in FIG. 1 located at the outlet end 7 of the separation pump 1 and located at the axis of rotation of the rotatable drum means 10.

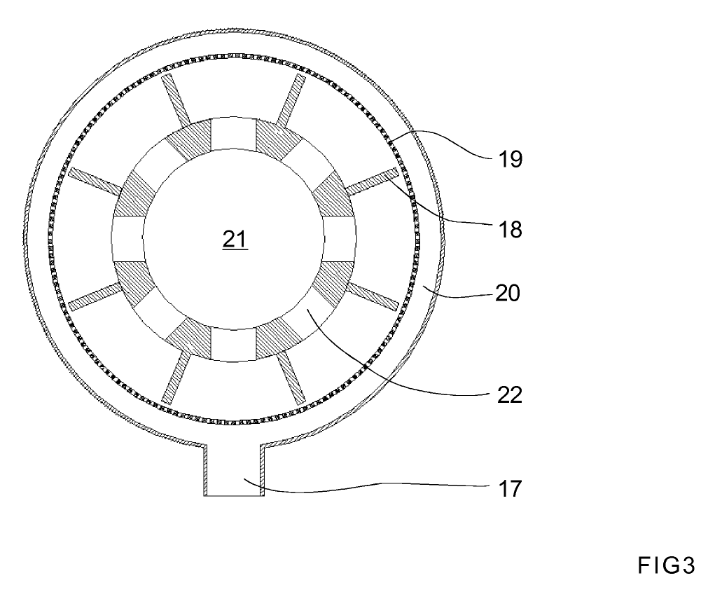

In FIG. 1, the foam extraction chamber 21 is provided with rotating means (not marked with a reference numeral) for rotating the foam extraction chamber 21 and the foam extraction chamber 21 is provided with holes 22, preferably for leading foam out of the foam extraction chamber 21 as the foam extraction chamber 21 rotates. In other words, because the foam extraction chamber 21 rotates, the holes 22 will cause a pumping action which further forces the foam out of the inner space 12 of the rotatable drum means 10. The foam extraction chamber 21 has preferably, but not necessarily, a cylindrical form and the holes 22 are preferably, but not necessarily formed in the cylindrical wall of the foam extraction chamber 21 as show in FIG. 1. In FIG. 1, the holes 21 lead foam to the rotating vanes 18, which force the foam through the screen 19 to the collector 20, from which the at least partly collapsed foam is lead of the foam discharging means 15 via the second outlet 17. In FIG. 3 the rotating vanes 18 are attached to the foam extraction chamber 21.

If the foam extraction chamber 21 rotates, the foam extraction chamber 21 is preferably, but not necessarily, adapted to rotate together with the rotatable drum means 10. Alternatively, the foam extraction chamber 21 may be provided with rotating means for rotating the foam extraction chamber 21.

The separation pump 1 shown in FIG. 1 comprises foam moving means 23 for causing foam flow from inner space 12 of the rotatable drum means 10 towards and/or into the foam extraction chamber 21. In FIG. 1, the foam moving means 23 comprises an impeller 24 or a similar type of rotating means for sucking foam out of the inner space 12 of the rotatable drum means 10 and for pumping the foam into the foam extraction chamber 21. The impeller 24 or a similar type of rotating means foam moving means 23 can comprise radials vanes 37, which act as a fan or a blower for causing foam to flow from the inner space 12 of the rotatable drum means 10 towards and/or into the foam extraction chamber 21. The foam moving means 23 are preferably, but not necessarily, configured for at least partly breaking down the foam prior pumping the foam into the foam discharging means 15.

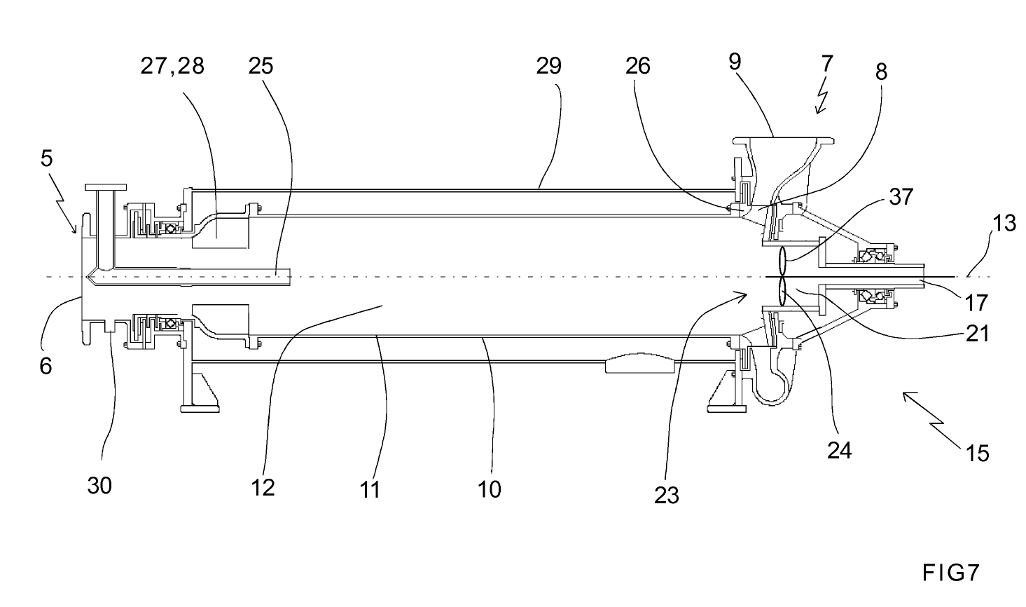

FIG. 7 shows a separation pump according to a fourth embodiment of the invention where the form moving means 23 comprises an impeller having rotating radial vanes 37 for causing foam to flow from inner space 12 of the rotatable drum means 10 towards the second outlet 17 of the foam discharging means 15. In FIG. 7, the radial vanes 37 are also configured for at least partly mechanically breaking down foam by hitting the foam with the radial vanes 37 as the radial vanes 37 rotates and foam passes the radial vanes 37 on the way from the inner space 12 of the rotatable drum means 10 to the second outlet 17 prior feeding foam in at least partly broken down state to the second outlet 17.

The foam moving means 23 are preferably, but not necessarily, arranged at the outlet end 7 of the separation pump 1. In the separation pump shown in FIG. 7, the foam moving means 23 are arranged between the rotatable drum means 10 and the second outlet 17 of the foam discharging means 15. Because the foam moving means 23 are arranged between the rotatable drum means 10 and the second outlet 17, the radial vanes 37 of the form moving means 23 can in this fourth embodiment of the invention at least partly mechanically break down foam prior feeding the foam in at least partly broken down state to the second outlet 17. Alternatively the moving means 23 can be arranged at least partly in the rotatable drum means 10 or at least partly in the second outlet 17. Alternatively the moving means 23 can be arranged in the rotatable drum means 10 or in the second outlet 17.

The separation pump 1 can preferably, but not necessarily, comprise pressure increasing means (not shown in the figures) for increasing the pressure in the inner space 12 of the rotatable drum means 10 for pressing foam to the foam discharging means 15, in FIG. 1 into the foam extraction chamber 21. Such pressure increasing means are preferably, but not necessarily, connected to a second inlet 25 at the inlet end 5.

The separation pump 1 can preferably, but not necessarily, comprise pressure decreasing means (not shown in the figures) for decreasing pressure in the inner space 12 of the rotatable drum means 10 for sucking foam to the foam discharging means 15, in FIG. 1 into the foam extraction chamber 21. Such pressure decreasing means are preferably, but not necessarily, connected to the second outlet 17.

The rotatable drum means 10 has preferably, but not necessarily, a generally cylindrical configuration or at least a part of the rotatable drum means 10 has preferably, but not necessarily, a generally cylindrical configuration. The generally cylindrical configuration of the rotatable drum means 10 has preferably, but not necessarily a diameter to length ratio of 1:1 to 1:20.

The rotatable drum means 10 extends preferably, but not necessarily, into the pump housing 8 at the outlet end 7. If the rotatable drum means 10 extends into the pump housing 8 at the outlet end 7, the diameter of the portion of the rotatable drum means 10 located in the pump housing 8 is preferably, but not necessarily, larger than the diameter of the rest of the rotatable drum means 10.

The rotatable drum means 10 may alternatively end at the pump housing 8 at the outlet end 7.

The rotatable drum means 10 comprises preferably, but not necessarily, a blade wheel 26 extending into the stationary pump housing 8.

In FIGS. 1 to 4, the separation pump 1 comprises additional rotation means 27 for rotating the fluid mixture 2 at the inlet end 5 of the rotatable drum means 10. The additional rotation means 27 comprises in FIGS. 1 to 4 a set of blades 28 extending from the inner wall 11 of the rotatable drum means 10 towards the center thereof. At least one of the blades has preferably, but not necessarily, an at least partly curved and/or spiral configuration.

The foam discharging means 15 are preferably, but not necessarily, located in the direction of the axis of rotation 13 of the rotatable drum means 10 after the outlet end 7 of the rotatable drum means 10. In FIG. 1, the foam extraction chamber 21 is located in the direction of the axis of rotation 13 of the rotatable drum means 10 after the outlet end 7 of the rotatable drum means 10.

The separation pump 1 shown in FIGS. 1 to 4 is provided with a Housing 29. The separation pump 1 shown in FIGS. 1 to 4 is provided with bearings (not marked with a reference numeral).

The inlet end 5 of the separation pump is preferably, but not necessarily, provided with a third inlet 30 for feeding air/gas or chemical(s) or foaming agents for forming foam into the fluid mixture 2. It is also possible to feed air/gas or chemical(s) or foaming agents into the separation pump via the second inlet 25.

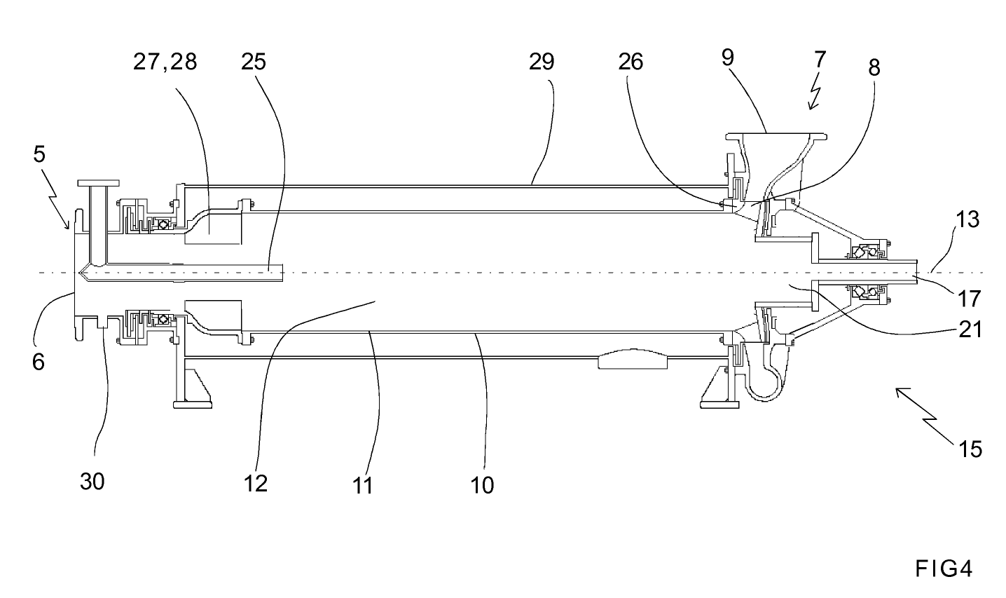

FIG. 4 shows a separation pump according to a second embodiment of the invention. The foam discharging means 15 of this separation pump does not comprise any foam breaking means.

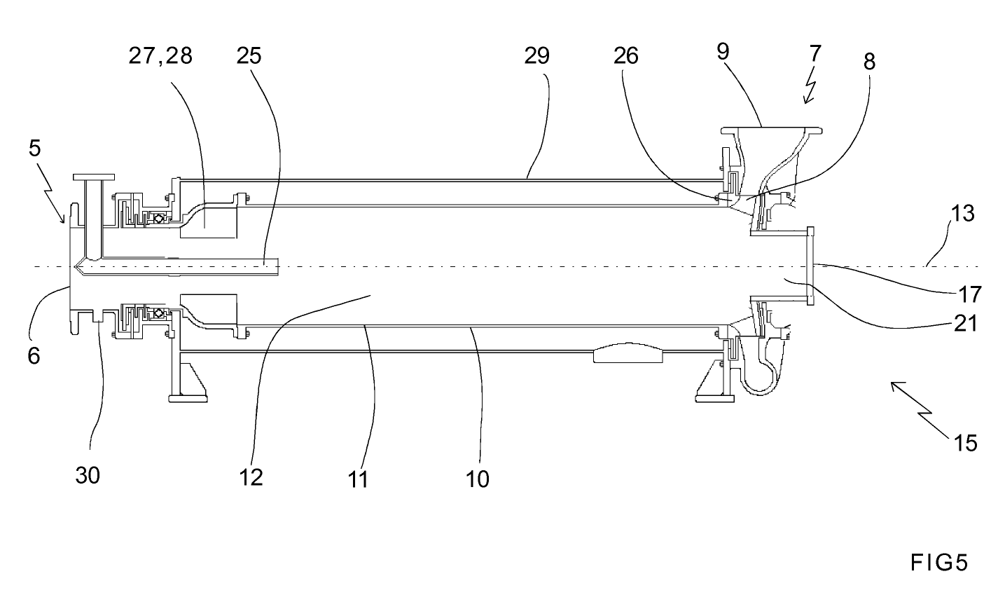

FIG. 5 shows a separation pump according to a third embodiment of the invention. The foam discharging means 15 of this separation pump does not comprise any foam breaking means. The second outlet 17 of foam discharging means 15 of the separation pump shown in FIG. 5 is designed and dimensioned so that foam can be discharged from the inner space 12 of the rotatable drum means 10 without breaking down the foam and at the same time from separation pump 1 without breaking down the foam.

The invention also relates to the use of a separation pump in a pulp mill process for separating soap from a mixture.

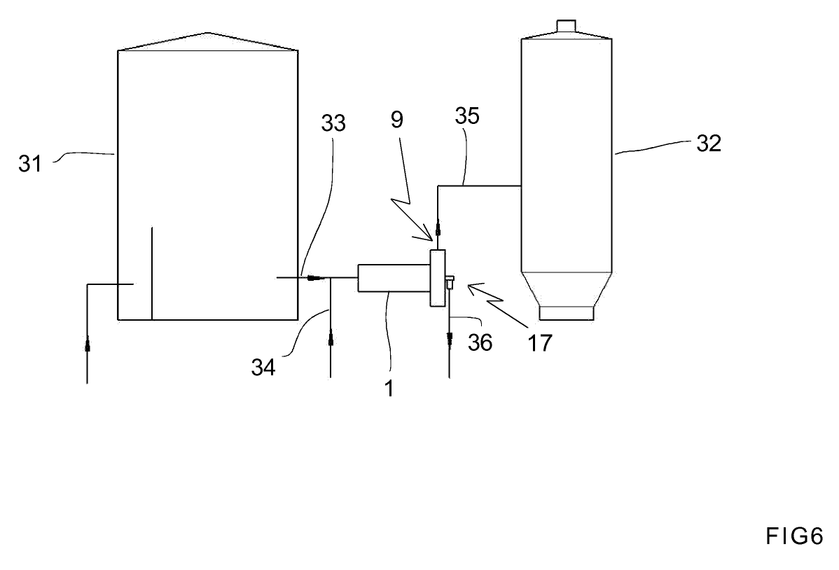

FIG. 6 shows use of a separation pump according to the invention in a pulp mill process separating soap from a mixture. In FIG. 6 the separation pump is arranged between a tank 31, which may be for example an impregnation liquor tank containing liquor for impregnating the wood chips prior to a digestion operation, and a digester 32, which may be a batch digester in which wood chips are digested to dissolve the lignin contained in the wood chips so as to produce cellulose pulp. An inlet line 33 is arranged between the tank 31 and the separation pump 1. An additional inlet line 34 for feeding foaming agents is in communication with the inlet line 33. A first outlet line 35 is connected to the first outlet 9 of the separation pump 1 for leading essentially gas-free and essentially soap-free liquid or suspension from the separation pump 1 to the digester 32. A second outlet line 36 is connected to the second outlet 17 of the separation pump 1 for leading foam, soap and/or gas from the separation pump.

It is apparent to a person skilled in the art that as technology advanced, the basic idea of the invention can be implemented in various ways. The invention and its embodiments are therefore not restricted to the above examples, but they may vary within the scope of the claims.

1. Separation pump (1) for pumping a fluid mixture (2) of gas (3) and liquid or suspension (4) and for at least partly separating gas (3) and liquid or suspension (4) from each other, the separation pump (1) comprising:
an inlet end (5) with a fluid mixture inlet (6) and at an opposite outlet end (7), a pump housing (8) with a first outlet (9) for liquid or suspension,
rotatable drum means (10) for rotating fluid mixture (2) fed through the fluid mixture inlet (6), the rotatable drum means (10) being provided between the inlet end (5) and the pump housing (8),
the rotatable drum means (10) having an essentially circular cross-section,
the rotatable drum means (10) having an inner wall (11),
the rotatable drum means (10) forming an inner space (12),
the rotatable drum means (10) being rotatable around an axis of rotation (13) for causing liquid or suspension (4) of fluid mixture (2) fed into the rotatable drum means (10) via the fluid mixture inlet (6) to form a layer of liquid or suspension (4) on the inner wall (11) and for causing gas (3) of fluid mixture (2) fed into the rotatable drum means (10) via the fluid mixture inlet (6) to migrate towards the axis of rotation (13) of the rotatable drum means (10),
foam discharging means (15) for discharging foam (16) from the inner space (12) of the rotatable drum means (10), said foam discharging means (15) comprises a second outlet (17).

2. Separation pump according to claim 1, wherein the foam discharging means (15) are provided at the axis of rotation (13) of the rotatable drum means (10).

3. Separation pump according to claim 1, wherein the foam discharging means (15) are provided at the outlet end (7) of the separation pump (1).

4. Separation pump according to claim 1, wherein the foam discharging means (15) comprises foam breaking means for at least partly breaking down the foam (16).

5. Separation pump according to claim 4, wherein the foam breaking means for at least partly breaking down the foam (16) are mechanical foam breaking means for breaking down the foam (16) mechanically.

6. Separation pump according to claim 5, wherein the mechanical foam breaking means comprises rotating vanes (18) for breaking the foam (16),
the mechanical foam breaking means comprises a screen (19) for breaking the foam (16),
the rotating vanes (18) are configured to co-operate with the screen (19) to force foam (16) with the rotating vanes (18) through the screen (19) to a collector (20), and
the collector (20) is in communication with the second outlet (17) for leading at least partly collapsed foam out of the separation pump (1).

7. Separation pump according to claim 1, wherein the foam discharging means (15) comprises a foam extraction chamber (21) for receiving foam from the inner space (12) of the rotatable drum means (10),
the foam extraction chamber (21) is located at the outlet end (7) of the separation pump (1), and
the foam extraction chamber (21) is located at the axis of rotation (13) of the rotatable drum means (10).

8. Separation pump according to claim 7, wherein the foam extraction chamber (21) is provided with rotating means for rotating the foam extraction chamber (21), and
the foam extraction chamber (21) is provided with holes (22), preferably for leading foam out of the foam extraction chamber (21) as the foam extraction chamber (21) rotates.

9. Separation pump according to claim 8, wherein the foam extraction chamber (21) is configured to rotate together with the rotatable drum means (10).

10. Separation pump according to claim 1, further comprising foam moving means (23) for causing foam to flow from inner space (12) of the rotatable drum means (10) towards the foam discharging means (15).

11. Separation pump according to claim 10, wherein the foam moving means (23) comprises an impeller (24) or similar means for sucking foam out of the inner space (12) of the rotatable drum means (10) and for pumping the foam into the foam discharging means (15).

12. Separation pump according to claim 10, wherein the foam moving means (23) are configured for at least partly breaking down the foam prior pumping the foam into the foam discharging means (15).

13. Separation pump according to claim 10, wherein the foam moving means (23) are arranged at the outlet end (7) of the separation pump (1).

14. Separation pump according to claim 10, wherein the foam moving means (23) are arranged between the rotatable drum means (10) and the second outlet (17) of the foam discharging means (15).

15. Separation pump according to claim 1, further comprising pressure increasing means for increasing the pressure in the inner space (12) of the rotatable drum means (10) for pressing foam to the foam discharging means (15).

16. Separation pump according to claim 15, wherein the pressure increasing means are connected to a second inlet (25) at the inlet end (5).

17. Separation pump according to claim 1, further comprising pressure decreasing means for decreasing pressure in the inner space (12) of the rotatable drum means (10) for sucking foam (16) to the foam discharging means (15).

18. Separation pump according to claim 17, wherein the pressure decreasing means are connected to the second outlet (17).

19. Separation pump according to claim 1, wherein the rotatable drum means (10) have a generally cylindrical configuration or that a portion of the rotatable drum means (10) have a generally cylindrical configuration, and
the generally cylindrical configuration has a diameter to length ratio of 1:1 to 1:20.

20. Separation pump according to claim 1, wherein the rotatable drum means (10) extends into the pump housing (8) at the outlet end (7).

21. Separation pump according to claim 1, wherein the rotatable drum means (10) comprises a blade wheel (26) extending into the stationary pump housing (8).

22. Separation pump according to claim 1, further comprising additional rotation means (27) for rotating the fluid mixture (2) at the inlet end (5) of the rotatable drum means (10).

23. Separation pump according to claim 22, wherein additional rotation means (27) comprises a set of blades (28) extending from the inner wall (11) of the rotatable drum means (10) towards the center thereof, and
the blades (28) have a at least partly curved configuration.

24. Separation pump according to claim 1, wherein the foam discharging means is located in the direction of the axis of rotation (13) of the rotatable drum means (10) after the outlet end (7) of the rotatable drum means (10).

25. A method of separating soap from a mixture in a pulp mill processing using the separation pump according to claim 1.

26. A method of separating components of mixture capable of foaming from the mixture in a pulp mill processing using the separation pump according to claim 1.

27. A method of separating components of foam from a mixture in a pulp mill processing using the separation pump according to claim 1.
